(19) United States
(12) Patent Application Publication
(10) Pub. No.: US 2026/0253393 A1
(43) Pub. Date: Aug. 27, 2026

(54) LIVENESS DETECTION MODEL TRAINING METHOD AND APPARATUS, DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Keyue ZHANG, Shenzhen (CN); Jiamu SUN, Shenzhen (CN); Taiping YAO, Shenzhen (CN); Shouhong DING, Shenzhen (CN); Rongrong JI, Shenzhen (CN)

(73) Assignee: TENCENT TECHNOLOGY (SHENZHEN) COMPANY LIMITED, Shenzhen (CN)

(21) Appl. No.: 19/642,982

(22) Filed: Apr. 9, 2026

Related U.S. Application Data
(63) Continuation of application No. PCT/CN2024/136371, filed on Dec. 3, 2024.

(30) Foreign Application Priority Data
Jan. 2, 2024 (CN) 202410014668.5

(51) Int. Cl. G06V 10/774; G06V 10/80; G06V 10/82; G06V 40/40

(52) U.S. Cl. CPC G06V 10/774; G06V 10/806; G06V 10/82; G06V 40/40

(57) ABSTRACT

A liveness detection model training method, apparatus, and computer-readable storage medium using text-guided style augmentation. The method acquires image samples with first and second description texts, the second text representing a target style. First augmented image features are generated through style augmentation based on both description texts, while second augmented image features are generated using style augmentation parameters. These parameters are updated based on differences between the two augmented features. Target style augmentation parameters are acquired from the updated parameters and used to generate target augmented image features. The liveness detection model is trained using these target features, enabling improved model robustness through controlled style variation guided by textual descriptions.

### CROSS-REFERENCE TO RELATED APPLICATIONS

This application is a continuation application of International Application No. PCT/CN2024/136371 filed on Dec. 3, 2024 which claims priority to Chinese Patent Application No. 202410014668.5, filed with the China National Intellectual Property Administration on Jan. 2, 2024, the disclosures of each being incorporated by reference herein in their entireties.

### FIELD

The disclosure relates to the field of artificial intelligence technologies, a liveness detection model training method and apparatus, a device, a computer-readable storage medium, and a computer program product.

### BACKGROUND

In the related art, liveness detection may be implemented by using a liveness detection model, and the liveness detection model may be trained by constructing a training sample based on existing presentation attack data. However, with increasing application of liveness detection, new presentation attack data may be generated quickly. Consequently, the liveness detection model trained only based on the existing presentation attack data has problems such as an insufficient model generalization capability and poor liveness detection effect.

### SUMMARY

Provided are a liveness detection model training method and apparatus, a device, a storage medium, and a program product, which can implement enhanced liveness detection model training through text-guided style augmentation and parameter optimization.

According to some embodiments, a liveness detection model training method, performed by an electronic device, includes: acquiring an image sample for training a liveness detection model, acquiring a first description text of the image sample and second description text of the image sample in a target style; generating a first augmented image feature by performing style augmentation on an image feature of the image sample based on the first description text and the second description text; generating a second augmented image feature by performing style augmentation on the image feature based on a style augmentation parameter; updating the style augmentation parameter based on a difference between the first augmented image feature and the second augmented image feature; acquiring a target style augmentation parameter based on the updated style augmentation parameter; acquiring a target augmented image feature of the image sample by performing style augmentation on the image feature based on the target style augmentation parameter; and training the liveness detection model based on the target augmented image feature.

According to some embodiments, a liveness detection model training apparatus, includes: at least one memory configured to store program code; and at least one processor configured to read the program code and operate as instructed by the program code, the program code including: acquiring code configured to cause at least one of the at least one processor to acquire an image sample for training a liveness detection model; text code configured to cause at least one of the at least one processor to acquire a first description text of the image sample and second description text of the image sample in a target style; first generation code configured to cause at least one of the at least one processor to generate a first augmented image feature by performing style augmentation on an image feature of the image sample based on the first description text and the second description text; second generation code configured to cause at least one of the at least one processor to generate a second augmented image feature by performing style augmentation on the image feature based on a style augmentation parameter; updating code configured to cause at least one of the at least one processor to update the style augmentation parameter based on a difference between the first augmented image feature and the second augmented image feature; parameter code configured to cause at least one of the at least one processor to acquire a target style augmentation parameter based on the updated style augmentation parameter; feature code configured to cause at least one of the at least one processor to acquire a target augmented image feature of the image sample by performing style augmentation on the image feature based on the target style augmentation parameter; and training code configured to cause at least one of the at least one processor to train the liveness detection model based on the target augmented image feature.

According to some embodiments, a non-transitory computer-readable storage medium, storing computer code which, when executed by at least one processor, causes the at least one processor to at least: acquire an image sample for training a liveness detection model; acquire a first description text of the image sample and second description text of the image sample in a target style; generate a first augmented image feature by performing style augmentation on an image feature of the image sample based on the first description text and the second description text; generate a second augmented image feature by performing style augmentation on the image feature based on a style augmentation parameter; update the style augmentation parameter based on a difference between the first augmented image feature and the second augmented image feature; acquire a target style augmentation parameter based on the updated style augmentation parameter; acquire a target augmented image feature of the image sample by performing style augmentation on the image feature based on the target style augmentation parameter; and train the liveness detection model based on the target augmented image feature.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of skill in the art may still derive other drawings from these accompanying drawings without creative efforts. In addition, one of skill would understand that aspects of some embodiments may be combined together or implemented alone.

FIG. 1 is a schematic architectural diagram of a liveness detection model training system according to some embodiments.

FIG. 2 is a schematic structural diagram of an electronic device according to some embodiments.

FIG. 3 is a schematic flowchart of a liveness detection model training method according to some embodiments.

FIG. 4 is a schematic flowchart of performing style augmentation on an image feature according to some embodiments.

FIG. 5 is a schematic structural diagram of a machine learning model according to some embodiments.

FIG. 6 is a schematic flowchart of a liveness detection model training method according to some embodiments.

FIG. 7 is a schematic flowchart of a liveness detection model training method according to some embodiments.

FIG. 8 is a schematic diagram of training a liveness detection model according to some embodiments.

FIG. 9 is a schematic flowchart of a liveness detection method according to some embodiments.

FIG. 10 is a schematic structural diagram of a liveness detection model according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following description, the term “some embodiments” describes subsets of all possible embodiments, but “some embodiments” may be the same subset or different subsets of all the possible embodiments, and can be combined with each other without conflict.

The terms, involved in the following description, “first/second/third” are merely intended to distinguish similar objects rather than describing orders. “First/second/third” is interchangeable in proper circumstances to enable some embodiments to be implemented in other orders than those illustrated or described herein.

In the embodiment of this application, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an integrated module or unit including a function of the module or unit.

Unless otherwise defined, meanings of all technical and scientific terms used in some embodiments are the same as those usually understood by a person skilled in the technical field of this application. Terms used in some embodiments are merely intended to describe objectives of some embodiments, but are not intended to limit this application.

Before some embodiments are further described in detail, a description is made on nouns and terms in some embodiments, and the nouns and terms in some embodiments are applicable to the following explanations.
(1) Client: a client refers to an application program that is run in a terminal and configured to provide various services, such as a client supporting liveness detection (such as a client supporting payment or a client supporting identity authentication).
(2) “In response to” is configured for representing a condition or a status on which an executed operation depends, and when a dependent condition or status is satisfied, one or more executed operations may be in real time or may have a set delay. There is no limitation on a sequence in which the operations are performed without description.
(3) Computer vision (CV) is a science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, the computer vision studies related theories and technologies and attempts to establish an artificial intelligence system that can acquire information from images or multidimensional data. Large in model technologies bring an important change to the development of computer vision technologies. The pre-trained model in the vision fields such as swin-transformers, vision transformer (ViT), vision-mixture of experts (V-MOE), and masked autoencoder (MAE) may be quickly and widely applied to downstream tasks by fine-tuning. The computer vision technologies generally include technologies such as image processing, image identification, image semantic understanding, image retrieval, optical character recognition (OCR), video processing, video semantic understanding, video content/behavioral identification, three-dimensional object reconstruction, a 3-dimension (3D) technology, virtual reality, augmented reality, simultaneous positioning, and map construction, and further include biometric technologies and liveness detection technologies such as face recognition, and fingerprint recognition.
(4) Liveness detection is a method for determining genuine physiological features of an object in some scenarios such as identity authentication. For example, in face recognition applications, the liveness detection can verify whether an operation is performed by a genuine live object by requiring a combination of actions such as blinking, mouth opening, head shaking, or nodding, and by using techniques such as facial landmark localization and face tracking. It can effectively resist some attack methods such as photo attacks, video attacks, face swapping, mask attacks, occlusion attacks, 3D animation attacks, and screen recapture attacks, to safeguard user interests.
(5) A model generalization capability refers to a capability of a machine learning model to behave on new data in addition to training data. A model with a good generalization capability can still maintain relatively high accuracy and stability for unseen data. The generalization capability is a key factor for measuring whether the model can learn an essential rule from data instead of only fitting the training data.

Based on the foregoing descriptions of the nouns and terms in some embodiments, the following describes some embodiments in detail. Some embodiments provide a liveness detection model training method and apparatus, a liveness detection method and apparatus, an electronic device, a computer-readable storage medium, and a computer program product, to improve training effect of a liveness detection model and further improve a model generalization capability and liveness detection precision of a trained liveness detection model.

During example application of related data collection and processing in this application, the informed consent or individual consent of a personal information subject may be acquired in strict accordance with the requirements of relevant laws and regulations, and the subsequent data use and processing behavior is carried out within the scope of authorization of laws and regulations and the personal information subject.

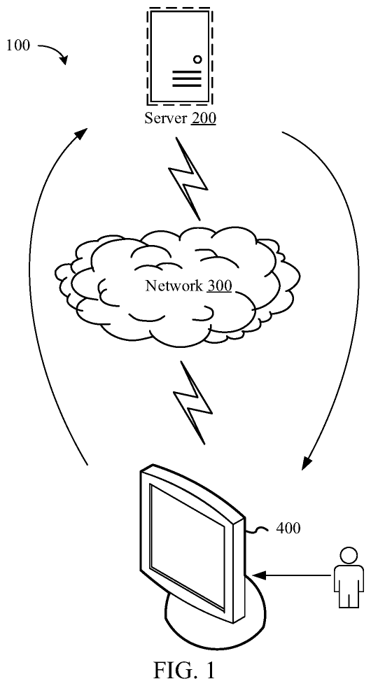

The following describes a liveness detection model training system according to some embodiments. FIG. 1 is a schematic architectural diagram of a liveness detection model training system according to some embodiments. To support an exemplary application, a liveness detection model training system 100 includes a server 200, a network 300, and a terminal 400. The terminal 400 is connected to the server 200 over the network 300. The network 300 may be a wide area network, a local area network, or a combination of the two, and implements data transmission by using a wireless or wired link.

Herein, the terminal 400 transmits, in response to an update instruction for a style augmentation parameter, an update request for a style augmentation parameter to the server 200. The server 200 receives the update request for the style augmentation parameter transmitted by the terminal 400; acquires, in response to the update request, an image sample for training a liveness detection model, and acquires first description text of the image sample and second description text of the image sample in a target style; performs style augmentation on an image feature of the image sample based on the first description text and the second description text to obtain a first augmented image feature, and performs style augmentation on the image feature based on the style augmentation parameter to obtain a second augmented image feature; and updates the style augmentation parameter based on a difference between the second augmented image feature and the first augmented image feature, to obtain a target style augmentation parameter.

In some exemplary scenarios, when the liveness detection model may be trained, the user may trigger a training instruction for the liveness detection model on the terminal 400. The terminal 400 transmits a training request for the liveness detection model to the server 200 in response to the training instruction for the liveness detection model. The server 200 receives the training request for the liveness detection model transmitted by the terminal 400; and performs, in response to the training request, style augmentation on the image feature based on the target style augmentation parameter to obtain a target augmented image feature of the image sample, and trains the liveness detection model based on the target augmented image feature, to obtain a trained liveness detection model.

In some example scenarios, after obtaining the trained liveness detection model, the server 200 may actively transmit the trained liveness detection model to the terminal 400, so that the terminal 400 can use the model when performing liveness detection. Certainly, the terminal 400 may further actively acquire the liveness detection model from the server 200 when performing liveness detection. In this case, the server 200 transmits the liveness detection model to the terminal 400 when the terminal 400 actively acquires the liveness detection model.

In some exemplary scenarios, the terminal 400 may be provided with a client supporting liveness detection. The user may trigger a liveness detection instruction for a to-be-detected image (including a biological object) on the terminal 400. The terminal 400 invokes the trained liveness detection model in response to the liveness detection instruction to perform liveness detection on the to-be-detected image, to obtain a liveness detection result. The liveness detection result includes a predicted probability that the biological object in the to-be-detected image belongs to each category, and the categories include a live category and at least one spoof category. In this way, whether the biological object is a genuine live object may be determined based on the predicted probability that the biological object belongs to each category in the liveness detection result. For example, a category corresponding to a maximum predicted probability is used as a target category to which the biological object belongs, if the target category is the live category, the biological object is a genuine live object, and if the target category is the spoof category, the biological object is not the genuine live object.

In some embodiments, the liveness detection model training method provided in some embodiments may be performed by an electronic device, for example, may be performed by a terminal alone, or may be performed by a server alone, or may be performed cooperatively by the terminal and the server. Some embodiments may be applied to various scenarios, including, but not limited to, cloud technologies, artificial intelligence, smart transportation, aided driving, computer vision, biometric payment, biometric unlocking (such as access control system unlocking or terminal device unlocking), biometric identity verification, and the like.

In some embodiments, an electronic device implementing the liveness detection model training method provided in some embodiments may be various types of terminals or servers. For example, the server (such as the server 200) may be an independent physical server, or a server cluster or a distributed system composed of a plurality of physical servers, or may be a cloud server, a cloud database, cloud computing, a cloud function, cloud storage, a network service, cloud communication, a middle-ware service, a domain name service, a security service, a content delivery network (CDN), and a cloud computing service such as big data and an artificial intelligence platform. The terminal (such as the terminal 400) may be a notebook computer, a tablet computer, a desktop computer, a smart-phone, a smart voice interaction device (such as a smart speaker), an intelligent appliance (such as a smart television), a smart-watch, an in-vehicle terminal, a wearable device, a virtual reality (VR) device, an aircraft, or the like, but is not limited thereto. The terminal and the server may be directly or indirectly connected through wired or wireless communication. This is not limited in some embodiments.

In some embodiments, the terminal or the server may implement the liveness detection model training method provided in some embodiments by running various computer-executable instructions or computer programs. For example, the computer-executable instructions may be a microprogram-level command, machine instructions, or software instructions. The computer program may be a native program or a software module in an operating system; may be a native application (APP), for example, a program that may be installed in an operating system to run; or may be a mini program that may be embedded in any APP, for example, a program that only may be downloaded into a browser environment to run. To sum up, the foregoing computer-executable instructions may be instructions in any form, and the foregoing computer program may be an application, a module, or a plug-in in any form.

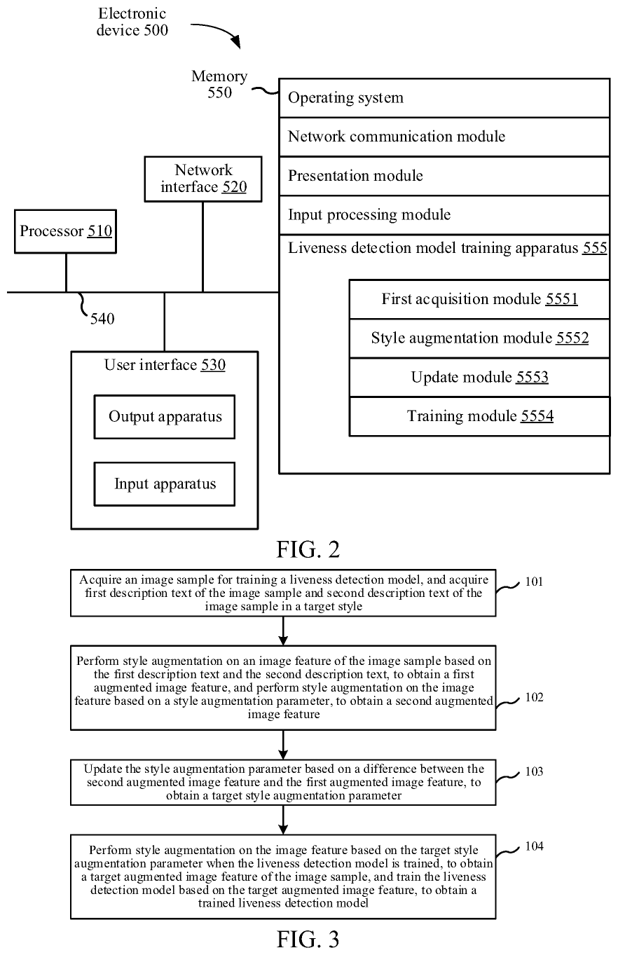

The electronic device implementing the liveness detection model training method provided in some embodiments is described below. FIG. 2 is a schematic structural diagram of an electronic device according to some embodiments. An electronic device 500 provided in some embodiments may be a terminal, or may be a server. As shown in FIG. 2, the electronic device 500 includes: at least one processor 510, a memory 550, at least one network interface 520, and a user interface 530. Components in the electronic device 500 are coupled together by using a bus system 540. The bus system 540 is configured to implement connection and communication between the components. In addition to a data bus, the bus system 540 further includes a power bus, a control bus, and a state signal bus. However, for ease of clear description, all types of buses in FIG. 2 are marked as the bus system 540.

In some embodiments, a liveness detection model training apparatus provided in some embodiments may be implemented by using software. FIG. 2 shows a liveness detection model training apparatus 555 stored in the memory 550. The liveness detection model training apparatus may be software in a form of a program, a plug-in, or the like, and includes the following software modules: a first acquisition module 5551, a style augmentation module 5552, an update module 5553, and a training module 5554, and these modules are logical. Therefore, these modules may further be combined or split in different manners based on implemented functions. The function of each module is described below.

A liveness detection model training method provided in some embodiments is described below. As described above, the liveness detection model training method provided in some embodiments is implemented by an electronic device, for example, may be independently implemented by a server or a terminal, or may be cooperatively implemented by the server and the terminal. Therefore, an execution body of each operation is not repeatedly described below. FIG. 3 is a schematic flowchart of a liveness detection model training method according to some embodiments. The liveness detection model training method provided in some embodiments includes:

Operation 101: Acquire an image sample for training a liveness detection model, and acquire first description text of the image sample and second description text of the image sample in a target style.

In operation 101, the image sample for training the liveness detection model is acquired, the image sample belongs to an image sample set for training the liveness detection model, the image sample set includes a plurality of image samples, and each image sample is an image including a biological object sample. The image sample may be obtained through the following operations: photographing a biological object sample in a live detection scenario and a background of the biological object sample by using a photographing device, to obtain the image sample. Furthermore, in a photographing process of an image photographing device, the biological object sample may perform a corresponding action based on a liveness detection requirement. For example, when the biological object sample is a hand, a corresponding gesture (such as an OK gesture or a single-finger gesture) may be made based on the liveness detection requirement. For another example, when the biological object sample is a human face, actions such as blinking, mouth opening, head shaking, and nodding may be made based on the liveness detection requirement. During actual application, a target image captured by the image photographing device may be directly used as an image sample, or the target image captured by the image photographing device may be cropped to obtain the image sample. For example, biological object detection may be performed on the target image, a first region in which the biological object sample is located in the target image is determined, and the first region is cropped from the target image as the image sample. Certainly, the image sample in a liveness detection scenario may include the background of the biological object sample. Therefore, after the first region is determined, a second region may be obtained by enlarging the first region by a predetermined multiple with the first region as the center, and the second region is cropped from the target image as the image sample. In this way, the image sample can include part of the background of the target image.

At the same time, first description text of the image sample and second description text of the image sample in a target style are further acquired. To be specific, the first description text is configured for describing the image sample, the first description text describes the image sample in an original style, and the original style is a real style of the image sample. The second description text describes the image sample in a target style, the target style is a style to be extended for the image sample, and the image sample having the target style is obtained by extending the style of the image sample. The target style includes, but is not limited to, a style in aspects such as illumination (such as high ambient light or dim ambient light), a background (such as a single background or a complex background), a posture of a biological object, and a facial expression. For example, the first description text of the image sample may be “a target image collected under the high ambient light”, and if the target style is yellow ambient light, the second description text may be “a target image collected under the yellow ambient light”.

In some embodiments, the style (such as the foregoing target style and original style) of the image (such as the foregoing image sample) configured for liveness detection refers to a unique feature and characteristic presented by the image in terms of visual effect. For example, the following describes some styles of an image for liveness detection, including: (1) dynamics: a liveness detection image usually includes a dynamic element, such as an action or an expression change of a human face, to simulate dynamic features of a genuine human face. (2) Multi-angle view: to better simulate a real situation, the liveness detection image may include a biological object (such as the human face) photographed from different angles, to improve a recognition capability of the liveness detection model at different angles. (3) Natural light and shadow: the liveness detection image may include a photo taken under natural light, and a shadow generated under different light conditions (such as backlight and side light). (4) Multiple backgrounds: to improve the universality of the liveness detection model, the liveness detection image may include a biological object (such as a human face) photographed in different background environments, including indoors, outdoors, and complex backgrounds. (5) Facial feature: the liveness detection image may highlight key parts of the biological object. Using a facial feature as an example, parts such as eyes, a nose, and a mouth may be highlighted, so that the liveness detection model can focus on these key parts for recognition. (6) Texture and details: to distinguish a genuine skin texture from a texture of a spoof material, the liveness detection image may include details of a biological object (such as a human face) with high resolution and rich details. (7) Facial expression and action: the liveness detection image may include biological objects having different facial expressions and actions. Using a human face as an example, actions such as blinking, mouth opening, and head shaking may be included, to improve a capability of the liveness detection model for a dynamic change. (8) Reflection and transmission characteristics: to simulate reflection and transmission characteristics of a genuine live object (such as a human face) under illumination, the liveness detection image may include a biological object (such as the human face) under different illumination conditions.

Operation 102: Perform style augmentation on an image feature of the image sample based on the first description text and the second description text, to obtain a first augmented image feature, and perform style augmentation on the image feature based on a style augmentation parameter, to obtain a second augmented image feature.

In operation 102, the image feature of the image sample may be first extracted. For example, a pre-trained first image encoder may be employed to perform image encoding on the image sample, to obtain the image feature of the image sample. For example, the first image encoder may be constructed based on a convolutional neural network, a recurrent neural network, a transformer network, or the like, and trained by using image data. For example, the first image encoder may include a plurality of cascaded image encoding layers. Downsampling processing is performed on the image sample by using the plurality of cascaded image encoding layers, to obtain the image feature. In this way, extraction effect of the image feature can be improved, so that a feature expression capability of the image feature for the image sample is higher. Then, style augmentation is performed on the image feature of the image sample based on the first description text and the second description text, to obtain the first augmented image feature. In this way, style augmentation can be performed on the image feature under the guidance of the second description text describing the image sample in the target style, to generate the first augmented image feature that corresponds to the image sample and that is fused with the target style.

In some embodiments, referring to FIG. 4, based on the first description text and the second description text, style augmentation may be performed on the image feature of the image sample through the following operations, to obtain the first augmented image feature. Operation 301: Perform text encoding on the first description text, to obtain a first text feature, and perform text encoding on the second description text, to obtain a second text feature. Operation 302: Perform image encoding on the image feature of the image sample, to obtain an encoded image feature. Operation 303: Fuse the second text feature, the first text feature, and the encoded image feature, to obtain the first augmented image feature.

In operation 301, text encoding is performed on the first description text and the second description text, respectively, to obtain the first text feature of the first description text and the second text feature of the second description text. For example, the text encoding may be implemented by using a pre-trained text encoder. For example, the text encoder may be constructed based on a convolutional neural network, a recurrent neural network, a transformer network, or the like, and trained by using text data. For example, the text encoder may include a plurality of cascaded text encoding layers. Downsampling processing is performed on the first description text by using the plurality of cascaded text encoding layers, to obtain the first text feature. The second description text is processed in the same way. In this way, extraction effect of the text features (including the first text feature and the second text feature) can be improved, so that a feature expression capability of the text features for the description text (including the first description text and the second description text) is improved. In operation 302, image encoding is performed on the image feature of the image sample, to obtain the encoded image feature. For example, image encoding may be implemented by using a pre-trained second image encoder. The second image encoder may be constructed based on a convolutional neural network, a recurrent neural network, a transformer network, or the like, and trained by using image data. For example, the second image encoder may include a plurality of cascaded image encoding layers. Downsampling processing is performed on the image feature by using the plurality of cascaded image encoding layers, to obtain the encoded image feature. In this way, the feature extraction effect can be further improved, so that a feature expression capability of the encoded image feature for the image sample is enhanced. In operation 303, the second text feature, the first text feature, and the encoded image feature are fused, to obtain the first augmented image feature. In this way, through operation 301 to operation 303, the first description text, the second description text, and the image feature are encoded, respectively, and the second text feature, the first text feature, and the encoded image feature are fused, to generate the first augmented image feature fused with the target style, thereby improving the style augmentation effect.

In some embodiments, operation 303 may be implemented by performing the following operations: determining a text feature difference between the second text feature and the first text feature; and fusing the text feature difference and the encoded image feature, to obtain the first augmented image feature. Herein, the first text feature may be subtracted from the second text feature, to obtain the text feature difference. When the text feature difference and the encoded image feature are fused, the text feature difference and the encoded image feature may be added, or the text feature difference and the encoded image feature may be multiplied, to obtain the first augmented image feature. In this way, the encoded image feature can be fused with the text feature difference between the second text feature and the first text feature, to implement the style augmentation of the target style of the image feature.

In operation 102, style augmentation is further performed on the image feature based on the style augmentation parameter, to obtain the second augmented image feature. In some embodiments, a style augmentation parameter is provided, and the style augmentation parameter is configured for performing style augmentation on the image feature of the image sample. The style augmentation parameter has an initial value, and the initial value may be preset based on experiences. Based on the first description text and the second description text, the style augmentation parameter may be learned, to obtain a better style augmentation parameter through learning, so that the second augmented image feature obtained by performing style augmentation on the image feature by using the learned style augmentation parameter is more similar to the first augmented image feature obtained by performing style augmentation on the image feature based on the first description text and the second description text.

In some embodiments, based on the style augmentation parameter, style augmentation may be performed on the image feature through the following operations, to obtain the second augmented image feature: fusing the style augmentation parameter and the image feature, to obtain a first fusion result; and performing image encoding on the first fusion result, to obtain the second augmented image feature. Herein, the style augmentation parameter and the image feature may be fused by adding the style augmentation parameter and the image feature, or may be fused by multiplying the style augmentation parameter and the image feature. When image encoding is performed on the first fusion result, image encoding may be performed on the first fusion result by using the pre-trained second image encoder, to obtain the second augmented image feature. The second image encoder may be constructed based on a convolutional neural network, a recurrent neural network, a transformer network, or the like, and trained by using image data. For example, the second image encoder may include a plurality of cascaded image encoding layers. Downsampling processing is performed on the first fusion result by using the plurality of cascaded image encoding layers, to obtain the second augmented image feature. In this way, the second augmented image feature can be more approximate to the target style, thereby improving style augmentation effect.

Operation 103: Update the style augmentation parameter based on a difference between the second augmented image feature and the first augmented image feature, to obtain a target style augmentation parameter.

In some embodiments, the style augmentation parameter may be learned, to obtain a better style augmentation parameter, so that the second augmented image feature obtained by performing style augmentation on the image feature by using the learned style augmentation parameter is more similar to the first augmented image feature obtained by performing style augmentation on the image feature based on the first description text and the second description text. Therefore, in operation 103, the style augmentation parameter may be updated based on the difference between the second augmented image feature and the first augmented image feature, to obtain the target style augmentation parameter.

In some embodiments, the style augmentation parameter belongs to a machine learning model. Based on this, based on the difference between the second augmented image feature and the first augmented image feature, the style augmentation parameter may be updated through the following operations, to obtain the target style augmentation parameter: acquiring a loss function of the machine learning model; determining a value of the loss function based on the difference between the second augmented image feature and the first augmented image feature; and updating the style augmentation parameter of the machine learning model based on the value of the loss function, to obtain the target style augmentation parameter.

Herein, the machine learning model may be pre-constructed, and the style augmentation parameter is a model parameter in the machine learning model. In this way, the foregoing second augmented image feature may be a prediction output when the machine learning model is trained, and the first augmented image feature may be a corresponding label. Therefore, the loss function of the machine learning model may be acquired, the value of the loss function is determined based on the difference between the second augmented image feature and the first augmented image feature, and further the machine learning model is trained based on the value of the loss function, to update the model parameter of the machine learning model. In this way, in a process of training the machine learning model, the style augmentation parameter is updated. After a training target (such as completing a preset number of rounds of training or satisfying a training ending condition by the value of the loss function) of the machine learning model is achieved, the style augmentation parameter obtained in the last round is used as the target style augmentation parameter. In an actual application, when the machine learning model is trained, each model parameter that may be updated in the machine learning model may be updated, and the model parameter that may be updated includes the foregoing style augmentation parameter. Certainly, when the machine learning model is constructed, the machine learning model is ensured to include only one model parameter that may be learned, for example, only includes the style augmentation parameter that may be learned, and another model parameter is pre-learned and frozen. Consequently, the learning efficiency of the style augmentation parameter can be improved.

In some embodiments, the loss function includes a first loss function and a second loss function. In this way, based on the difference between the second augmented image feature and the first augmented image feature, the value of the loss function may be determined through the following operations: determining a value of the first loss function based on the difference between the second augmented image feature and the first augmented image feature; and determining a value of the second loss function based on the difference between the second augmented image feature and the image feature; and adding the value of the first loss function and the value of the second loss function, to obtain the value of the loss function.

The difference between the second augmented image feature and the first augmented image feature may be first determined, and then the value of the first loss function is determined based on the difference between the second augmented image feature and the first augmented image feature. In this way, the second augmented image feature can be constrained to approximate the first augmented image feature by using the first loss function. Then, the difference between the second augmented image feature and the image feature is determined, so that the value of the second loss function is determined based on the difference between the second augmented image feature and the image feature. In this way, a distance between the second augmented image feature and the image feature without undergoing style augmentation is constrained not to exceed a distance threshold by using the second loss function. Based on this, by means of joint constraint of the first loss function and the second loss function, the second augmented image feature based on the style augmentation parameter can be ensured to approximate the first augmented image feature guided by text, and the distance between the second augmented image feature based on the style augmentation parameter and the un-augmented image feature can further be ensured not to exceed the distance threshold, to improve learning precision of the style augmentation parameter, so that the target style augmentation parameter obtained by learning can augment the target style of the image feature more accurately, thereby improving the style augmentation effect of the target style. When the value of the second loss function is determined, the value may be determined based on the difference between the second augmented image feature and the encoded image feature, because both the image features and the encoded image features are image features of the image sample without undergoing style augmentation.

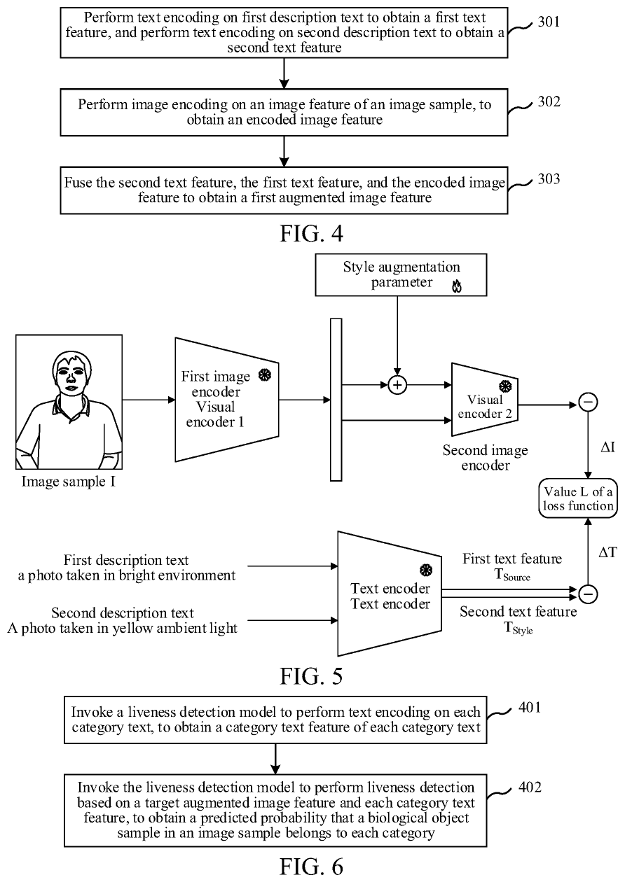

As an example, FIG. 5 is a schematic structural diagram of a machine learning model according to some embodiments. Herein, the machine learning model includes: a text encoder, a first image encoder (visual encoder 1, denoted as Vₐ), and a second image encoder (visual encoder 2, denoted as V_{b}). Specifically, text encoding is performed on the first description text (i.e., a photo taken in a bright environment) by using the text encoder, to obtain a first text feature (i.e., T_{source}), and text encoding is performed on the second description text (i.e., a photo taken in yellow ambient light) by using the text encoder, to obtain a second text feature (i.e., T_{style}). The first text feature is subtracted from the second text feature, to obtain a text feature difference (i.e., ΔT=T_{style}−T_{source}). Image encoding is performed on the image sample 1 by using the first image encoder to obtain the image feature (i.e., F=Vₐ(I)), and image encoding is performed on the image feature by using the second image encoder to obtain an encoded image feature (i.e., V_{b}(F)). The text feature difference ΔT and the encoded image feature V_{b}(F) are added to obtain a first augmented image feature (i.e., F_{gt}=V_{b}(F)+ΔT). The style augmentation parameter A0 and the image feature F are added to obtain a first addition result, and image encoding is performed on the first addition result, to obtain a second augmented image feature (i.e., F_{pred}=V_{b}(F+A0)).

Based on this, the value of the loss function may be determined by using the loss function shown in the following formula (1), and then the style augmentation parameter A0 is updated based on the value of the loss function, to obtain the target style augmentation parameter A:

$$L = 1 - cos ( {F}_{pred} , {F}_{gt} ) + {L}_{1} ( {F}_{pred} , {V}_{b} ( F ) ) ; \qquad formula ( 1 )$$

where L denotes the value of the loss function, 1−cos (F_{pred}, F_{gt}) denotes the value of the first loss function, and L₁(F_{pred}, V_{b}(F)) denotes the value of the second loss function. In FIG. 5, ΔI=V_{b}(F+A)−V_{b}(F), and the value L of the loss function is further equivalent to constraining ΔI to approximate ΔT. Since a learning process of updating the style augmentation parameter A0 to the target style augmentation parameter A is usually performed in multiple iterations, and one style augmentation parameter is obtained in each iteration, the style augmentation parameter shown in FIG. 5 refers to the style augmentation parameter and a style augmentation parameter outputted in each round of the learning process, and the style augmentation parameter outputted in the last round is the target style augmentation parameter A.

Operation 104: Perform style augmentation on the image feature based on the target style augmentation parameter when the liveness detection model is trained, to obtain a target augmented image feature of the image sample, and train the liveness detection model based on the target augmented image feature, to obtain a trained liveness detection model.

In this way, through the foregoing operation 101 to operation 103, the learned target style augmentation parameter is obtained. In operation 104, when the liveness detection model may be trained, style augmentation may be performed on the image feature of the image sample based on the target style augmentation parameter to obtain the target augmented image feature, and then the liveness detection model is trained based on the target augmented image feature, to obtain the trained liveness detection model. In this way, the image features of different styles can be added to the training samples for training the liveness detection model, thereby improving the training effect of the liveness detection model by using the image features of diversified styles of the training samples, improving the generalization capability of the trained liveness detection model, and further improving the liveness detection precision in a liveness detection scenario.

In some embodiments, based on the target style augmentation parameter, style augmentation may be performed on the image feature through the following operations, to obtain the target augmented image feature of the image sample: fusing the target style augmentation parameter and the image feature, to obtain a second fusion result; and performing image encoding on the second fusion result, to obtain the target augmented image feature of the image sample. Herein, the target style augmentation parameter and the image feature may be fused by adding the target style augmentation parameter and the image feature, or may be fused by multiplying the target style augmentation parameter and the image feature. When image encoding is performed on the second fusion result, image encoding may be performed on the second fusion result by using the pre-trained second image encoder to obtain the target augmented image feature. The second image encoder may be constructed based on a convolutional neural network, a recurrent neural network, a transformer network, or the like, and trained by using image data. For example, the second image encoder may include a plurality of cascaded image encoding layers. Downsampling processing is performed on the second fusion result by using the plurality of cascaded image encoding layers, to obtain the target augmented image feature. In this way, the second augmented image feature can be more approximate to the target style, thereby improving style augmentation effect.

In some embodiments, prior to the performing style augmentation on the image feature based on the target style augmentation parameter, to obtain a target augmented image feature of the image sample, the following operations may further be performed: acquiring a sample selection mode; and selecting, based on the sample selection mode, a to-be-augmented image sample on which style augmentation is to be performed from an image sample set of the image sample; and based on this, the performing style augmentation on the image feature based on the target style augmentation parameter through the following operations, to obtain the target augmented image feature of the image sample: when the image sample having the image feature is the to-be-augmented image sample, performing style augmentation on the image feature based on the target style augmentation parameter, to obtain the target augmented image feature of the image sample.

Herein, the to-be-augmented image sample (for example, the image sample on which style augmentation may be performed) may be all image samples in the image sample set, or may be some image samples in the image sample set. When the to-be-augmented image samples are some image samples in the image sample set, some image samples may be selected from the image sample set as the to-be-augmented image samples based on the sample selection mode. For example, the sample selection mode may include: presetting a proportion of a number of the to-be-augmented image samples to a total number of the image samples in the image sample set, and then selecting any image sample from the image sample set as the to-be-augmented image sample based on the proportion; or presetting a selection condition of the to-be-augmented image sample, and then selecting an image sample satisfying the selection condition as the to-be-augmented image sample.

Based on this, when style augmentation is performed on the image feature of the image sample, whether the image sample is the to-be-augmented image sample may be first determined. If the image sample is the to-be-augmented image sample, style augmentation is performed on the image feature based on the target style augmentation parameter, to obtain the target augmented image feature of the image sample, and then the liveness detection model is trained based on the target augmented image feature. If the image sample does not belong to a to-be-augmented image sample set, the liveness detection model is trained directly based on the image feature. Certainly, if style augmentation is performed on the image feature and the liveness detection model is trained by using the corresponding target augmented image feature, the liveness detection model may be trained by using the image feature without undergoing style augmentation.

In this way, the image features of different styles can be added to all or some image samples among the training samples for training the liveness detection model, to improve diversity of the image features of the training samples, thereby improving the training effect of the liveness detection model by using the image features of diversified styles of the training samples, improving the generalization capability of the trained liveness detection model, and further improving the liveness detection precision in a liveness detection scenario. At the same time, the to-be-augmented image sample is selected based on the sample selection mode, so that the data processing volume of style augmentation can be reduced, and the style augmentation efficiency can be improved, thereby improving the model training efficiency of the liveness detection model.

When the image sample having the image feature is the to-be-augmented image sample, after the target augmented image feature is obtained, the liveness detection model is trained based on the target augmented image feature; and when the image sample having the image feature is not the to-be-augmented image sample, the liveness detection model is trained directly based on the image feature. In this way, training the liveness detection model by collectively using the target augmented image feature and the image feature can improve the prediction precision of the trained liveness detection model, and can further improve the model training efficiency of the liveness detection model.

In some embodiments, based on the target augmented image feature, the liveness detection model may be trained through the following operations to obtain a trained liveness detection model: invoking the liveness detection model, and performing liveness detection based on the target augmented image feature, to obtain a liveness detection result of the image sample; and training the liveness detection model based on a difference between the liveness detection result and a sample label of the image sample to obtain the trained liveness detection model. In some examples, the liveness detection result may indicate whether the biological object sample in the image sample is a genuine live object. Further, the value of the loss function of the liveness detection model may be determined based on the difference between the liveness detection result and the sample label of the image sample. When the value of the loss function exceeds a loss threshold, an error signal of the liveness detection model is determined based on the loss function, and the error signal is back-propagated in the liveness detection model, so that in a back propagation process of error information, the model parameter of the liveness detection model is updated, thereby training the liveness detection model to obtain the trained liveness detection model.

When the liveness detection model is trained, iterative training is performed on the liveness detection model, for example, a plurality of rounds of training is performed on the liveness detection model, so that the model parameter of the liveness detection model outputted in a previous round of training is updated as the model parameter of the liveness detection model outputted by a current round of training, thereby obtaining the liveness detection model obtained by the current round of training. Furthermore, in each round of training, after the liveness detection model is obtained in the current round of training, whether the liveness detection model reaches a training target is further determined. The training target may be that a verification indicator (such as an error or accuracy of liveness detection) of the liveness detection model on a verification set reaches an indicator threshold (that may be preset), or may be that a number of rounds of training reaches a number threshold (that may be preset). When it is determined that the liveness detection model does not reach the training target, a next round of training is performed on the liveness detection model; and when it is determined that the liveness detection model reaches the training target, the training is stopped, and the liveness detection model obtained in the last round is outputted as a final liveness detection model. In this way, the training precision of the liveness detection model can be improved, and the training efficiency of the liveness detection model can be further ensured, thereby improving the training effect of the liveness detection model.

In some embodiments, prior to the training the liveness detection model based on the target augmented image feature to obtain a trained liveness detection model, the following operations may further be performed: training the liveness detection model based on the image feature, to obtain an intermediate liveness detection model; and based on this, training the liveness detection model based on the target augmented image feature by performing the following operations to obtain the trained liveness detection model: training the intermediate liveness detection model based on the target augmented image feature, to the trained liveness detection model.

Herein, the liveness detection model may be trained by using the target augmented image feature, and the liveness detection model may further be trained by using the original image feature. For a process of training the intermediate liveness detection model by using the target augmented image feature, refer to a process of training the liveness detection model by using the target augmented image feature. In this way, (1) diversity of the image features of the training samples is improved, thereby improving the training effect of the liveness detection model by using the image features of diversified styles of the training samples; (2) the liveness detection capability of the liveness detection model for the image sample of the original style is ensured; and in conclusion, the generalization capability of the trained liveness detection model is improved, thereby improving liveness detection precision in the liveness detection scenario.

In some embodiments, prior to the invoking a liveness detection model, and performing liveness detection based on the target augmented image feature, to obtain a liveness detection result of the image sample, the following operations may be performed: acquiring a plurality of pieces of category text, the plurality of pieces of category text including: first text representing a live category and a second text representing each spoof of at least one spoof category. Based on this, referring to FIG. 6, a liveness detection model is invoked, and liveness detection may be performed based on a target augmented image feature through the following operations to obtain a liveness detection result of an image sample. Operation 401: Invoke a liveness detection model to perform text encoding on each category text, to obtain a category text feature of each category text. Operation 402: Invoke the liveness detection model to perform liveness detection based on a target augmented image feature and each category text feature, to obtain a predicted probability that a biological object sample in the image sample belongs to each category, where the categories include a live category and at least one spoof category, and the liveness detection result of the image sample includes the predicted probability that the biological object sample belongs to each category.

Herein, when liveness detection is performed based on the target augmented image feature, a plurality of pieces of category text further need to be acquired. The plurality of pieces of category text include: first text representing the live category and second text representing the spoof category. The first text is configured for describing a biological object image of the live category (for example, an image including a genuine live object that is obtained by performing image collection on the genuine live object). The second text is configured for describing a biological object image of the spoof category (for example, an image without including a genuine live object, for example, obtained by performing image collection on a biological object in a video or picture played on a screen, or a pre-printed biological object). The number of the spoof category is at least one, such as a category of a video biological object and a category of a picture biological object.

Furthermore, after the plurality of pieces of category text are obtained, in operation 401, the liveness detection model is invoked to perform text encoding on each category text and obtain the category text feature of each category text. For example, text encoding may be implemented by using a pre-trained text encoder. For example, the text encoder may be constructed based on a convolutional neural network, a recurrent neural network, a transformer network, or the like, and trained by using text data. For example, the text encoder may include a plurality of cascaded text encoding layers. Downsampling processing is performed on the category text by using the plurality of cascaded text encoding layers, to obtain the category text feature. In this way, extraction effect of the category text feature can be improved, so that a feature expression capability of the text feature for the category text is improved. In operation 402, the liveness detection model is invoked to perform liveness detection based on the target augmented image feature and each category text feature, and obtain the predicted probability that the biological object sample in the image sample belongs to each category. The categories include the live category and at least one spoof category. In this embodiment, the liveness detection result of the image sample includes the predicted probabilities that the biological object sample belongs to the categories.

In this way, through operation 401 to operation 402, when the liveness detection model is invoked to perform liveness detection, liveness detection may be performed based on the category text features representing the live category and the spoof category. The category text features may express the feature of the live category and the feature of the spoof category, so that in a case that liveness detection is performed with reference to the category text features, the liveness detection accuracy of the liveness detection model can be improved.

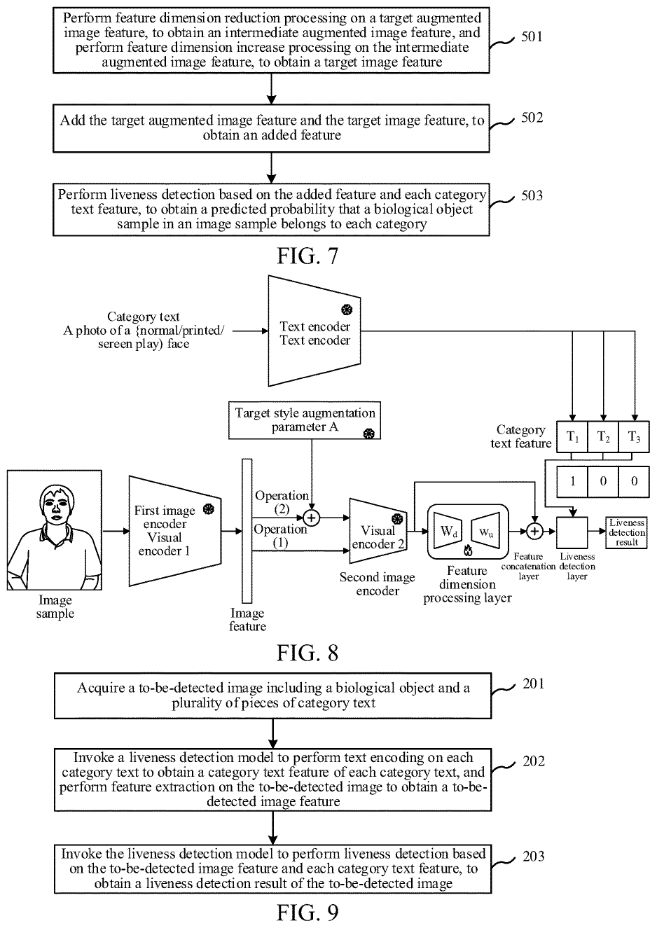

In some embodiments, referring to FIG. 7, liveness detection may be performed based on the target augmented image feature and the category text features through the following operations, to obtain the predicted probability that the biological object sample in the image sample belongs to each category. Operation 501: Perform feature dimension reduction processing on the target augmented image feature, to obtain an intermediate augmented image feature, and perform feature dimension increase processing on the intermediate augmented image feature, to obtain a target image feature. Operation 502: Add the target augmented image feature and the target image feature, to obtain an added feature. Operation 503: Perform liveness detection based on the added feature and each category text feature, to obtain the predicted probability that the biological object sample in the image sample belongs to each category.

Herein, in operation 501, feature dimension reduction processing is first performed on the target augmented image feature (for example, the feature dimension reduction processing may be implemented by using a pre-constructed encoder), to obtain the intermediate augmented image feature, and then feature dimension increase processing is performed on the intermediate augmented image feature (for example, the feature dimension increase processing may be implemented by using a pre-constructed decoder), to obtain the target image feature. The feature dimension reduction processing refers to reducing dimensions of a feature. In this way, the dimension of the intermediate augmented image feature is less than the dimension of the target augmented image feature. The feature dimension increase processing refers to increasing dimensions of a feature. In this way, the dimension of the target image feature is greater than the dimension of the intermediate augmented image feature. Further, in operation 502, the target augmented image feature and the target image feature are added, to obtain the added feature. Finally, in operation 503, liveness detection is performed based on the added feature and each category text feature, to obtain the predicted probability that the biological object sample in the image sample belongs to each category. Specifically, liveness detection is performed based on the added feature and each category text feature, and the predicted probability that the biological object sample belongs to each category may be obtained by using the following formula (2):

$${p}_{i}^{′} = \frac{exp ( {T}_{i} {E}_{v} ) / τ}{{\sum }_{j = 1}^{N} exp ( {T}_{j} {E}_{v} ) / τ} ; \qquad form ula ( 2 )$$

where pᵢ′ denotes the predicted probability that the biological object sample belongs to an i^{th} category, Tᵢ denotes a category text feature of the i^{th} category, Eᵥ denotes the added feature, t denotes a preset temperature coefficient, N denotes a number of categories, and Tⱼ denotes the category text feature of the j^{th} category.

Based on this, after the liveness detection result (for example, the predicted probability that the biological object sample belongs to each category) is obtained, the value L(θ) of the loss function of the liveness detection model may be determined by using the following formula (3):

$$L ( θ ) = - {\sum }_{i = 1}^{N} {y}_{i} log ( {p}_{i}^{′} ) ; \qquad formula ( 3 )$$

where y₁ denotes a real label indicating that the biological object in the image sample belongs to an i^{th} category (1 indicates that the biological object sample in the image sample belongs to the i^{th} category, and 0 indicates that the biological object sample in the image sample does not belong to the i^{th} category).

Therefore, the liveness detection model is trained based on the value L(θ) of the loss function, to obtain the trained liveness detection model.

In some embodiments, feature dimension reduction processing may be performed on the target augmented image feature to obtain the intermediate augmented image feature, and feature dimension increase processing may be performed on the intermediate augmented image feature to obtain the target image feature through the following operations: invoking a feature dimension processing layer of the liveness detection model to perform feature dimension reduction processing on the target augmented image feature to obtain the intermediate augmented image feature, and perform feature dimension increase processing on the intermediate augmented image feature to obtain the target image feature. Based on this, based on the difference between the liveness detection result and the sample label of the image sample, the liveness detection model may be trained through the following operations to obtain the trained liveness detection model: updating a model parameter of the feature dimension processing layer based on the difference between the liveness detection result and the sample label of the image sample, and training the liveness detection model, to obtain the trained liveness detection model.

Herein, when the liveness detection model is constructed, the to-be-learned model parameter may be set at the feature dimension processing layer of the liveness detection model, and another model parameter may be pre-learned and frozen. The to-be-learned model parameter of the feature dimension processing layer includes a first model parameter configured for feature dimension reduction processing and a second model parameter configured for feature dimension increase processing. In this way, the liveness detection model can be trained rapidly, thereby improving the model training efficiency. The feature dimension processing layer is configured for performing feature dimension reduction and dimension increase processing on the target augmented image feature. Specifically, the feature dimension processing layer includes a dimension reduction processing layer and a dimension increase processing layer. The dimension reduction processing layer is configured for performing dimension reduction processing on the target augmented image feature, to obtain the intermediate augmented image feature. In this way, a secondary feature in the target augmented image feature can be filtered, and a primary feature can be reserved, thereby reducing calculation resources for processing the secondary feature, and further obtaining a feature that can express the image more accurately. The dimension increase processing layer is configured for performing dimension increase processing on the target augmented image feature, to obtain the target image feature. In this way, a factor affecting a model detection result can be added based on the primary feature of the target augmented image feature, so that the model is better fitted, a problem of model under-fitting is resolved, the detection precision of the model is improved, and the model training effect is further improved.

As an example, FIG. 8 is a schematic diagram of training a liveness detection model according to some embodiments. Herein, the liveness detection model includes a text encoder (text encoder), a first image encoder (visual encoder 1), a second image encoder (visual encoder 2), and a feature dimension processing layer (including a dimension reduction processing layer (including a to-be-learned model parameter W_{d}) and a dimension increase processing layer (including a to-be-learned model parameter Wᵤ)), a feature concatenation layer, and a liveness detection layer. In this way, based on the liveness detection model shown in FIG. 8, first, the text encoder may be invoked to perform text encoding on each category text (as shown in FIG. 8, 3 categories of category text in total (i.e., a number N of categories is equal to 3), including a photo of a normal face (corresponding to a live category), a photo of a printed face (corresponding to a spoof category, for example, a category of a biological object in a picture), and a photo of a screen play face (corresponding to a spoof category, for example, a category of a biological object in a video)), to obtain a category text feature of each category text, including category text features T₁, T₂, and T₃. Herein, T₁ corresponds to 1, representing that T₁ denotes the category text of a live category. T₂ corresponds to 0, representing that T₂ denotes the category text of a spoof category. T₃ corresponds to 0, representing that T₃ denotes the category text of a spoof category. Next, the first image encoder is invoked to perform image encoding on the image sample, to obtain an image feature. Then one of the following operations (including an operation (1) and an operation (2)) are performed:

Operation (1): Invoke a second image encoder to perform image encoding on the image feature if it is determined that the current image sample is not a to-be-augmented image sample, to obtain an encoded image feature; invoke a feature dimension processing layer to process the encoded image feature, to obtain a target encoded image feature; invoke a feature concatenation layer to add the encoded image feature and the target encoded image feature, to obtain an added feature to increase the feature of the image sample without the feature dimension processing for the feature without the feature dimension processing, thereby improving the expression precision of the feature for liveness detection for the image sample; invoke a liveness detection layer to perform liveness detection based on the added feature and each category text feature, to obtain a liveness detection result of the image sample; and update model parameters W_{d} and W_{d} of the feature dimension processing layer based on a difference between the liveness detection result and the sample label of the image sample, and train the liveness detection model to obtain a trained liveness detection model.

Operation (2): If it is determined that the current image sample is a to-be-augmented image sample, add a target style augmentation parameter and the image feature, to obtain a second addition result, and perform image encoding on the second addition result, to obtain a target augmented image feature of the image sample; perform feature dimension reduction processing on the target augmented image feature, to obtain an intermediate augmented image feature, and perform feature dimension increase processing on the intermediate augmented image feature, to obtain a target image feature; and invoke the feature concatenation layer to add the target augmented image feature and the target image feature, to obtain an added feature, to increase the feature of the image sample without undergoing feature dimension processing for the image without undergoing feature dimension processing, thereby improving the expression precision of the feature configured for liveness detection for the image sample; invoke a liveness detection layer to perform liveness detection based on the added feature and each category text feature, to obtain a liveness detection result of the image sample; and further update model parameters W_{d} and Wᵤ of the feature dimension processing layer based on a difference between the liveness detection result and the sample label of the image sample, and train the liveness detection model to obtain a trained liveness detection model.

By using the some embodiments, the image sample for training the liveness detection model, the first description text of the image sample, and the second description text of the image sample in the target style are first acquired. Then, style augmentation is performed on the image feature of the image sample based on the first description text and the second description text to obtain the first augmented image feature, and style augmentation is performed on the image feature based on the style augmentation parameter to obtain the second augmented image feature. The style augmentation parameter is updated based on the difference between the second augmented image feature and the first augmented image feature, to obtain the target style augmentation parameter. In this way, when the liveness detection model is trained, style augmentation is performed on the image feature based on the target style augmentation parameter to obtain the target augmented image feature of the image sample, and the liveness detection model is trained based on the target augmented image feature to obtain the trained liveness detection model. Herein, the target style augmentation parameter is learned in a text-guided mode, and the target style augmentation parameter is configured for performing style augmentation on the image feature of the image sample to obtain the target augmented image feature, thereby implementing style diversification on the existing image feature of the image sample, and enriching the image feature of the image sample. Further, when the liveness detection model is trained by using the target augmented image feature of the image sample, training effect of the liveness detection model can be improved, thereby improving the model generalization capability and liveness detection precision of the trained liveness detection model.

The following describes a liveness detection method according to some embodiments. The liveness detection method provided in some embodiments is implemented by an electronic device, for example, may be independently implemented by a server or a terminal, or may be cooperatively implemented by the server and the terminal. Therefore, an execution body of each operation is not repeatedly described below. FIG. 9 is a schematic flowchart of a liveness detection method according to some embodiments. The liveness detection method provided in some embodiments includes:

Operation 201: Acquire a to-be-detected image including a biological object and a plurality of pieces of category text.

The plurality of pieces of category text include: first text representing a live category and second text representing each spoof category of at least one spoof category.

In operation 201, when liveness detection may be performed on the biological object, a user may trigger a liveness detection instruction on an electronic device, and the electronic device acquires the to-be-detected image including the biological object in response to the liveness detection instruction. Herein, a to-be-detected biological object and a background where the biological object is located in a liveness detection scenario are captured by an image photographing device, to obtain the to-be-detected image. Furthermore, in a photographing process of the image photographing device, the biological object may make a corresponding action based on a liveness detection requirement. For example, when the biological object is a hand, a corresponding gesture may be made based on the liveness detection requirement. For another example, when the biological object is a human face, actions such as blinking, mouth opening, head shaking, and nodding may be made based on the liveness detection requirement. During actual application, the target image captured by the image photographing device may be directly used as the to-be-detected image, or the target image captured by the image photographing device may be cropped to obtain the to-be-detected image. For example, biological object detection may be performed on the target image, a first region where the biological object is located in the target image is determined, and the first region is cropped from the target image as the to-be-detected image. Certainly, the to-be-detected image in the liveness detection scenario may include the background where the biological object is located. Therefore, after the first region is determined, a second region may be obtained by enlarging the first region by a predetermined multiple with the first region as the center, and the second region is cropped from the target image as the to-be-detected image. In this way, the to-be-detected image can include part of the background.

In operation 201, a plurality of pieces of category text are further acquired. The plurality of pieces of category text include: the first text representing the live category and the second text representing the spoof category. The first text is configured for describing a biological object image of the live category (for example, an image including a genuine live object that is obtained by performing image collection on the genuine live object). The second text is configured for describing a biological object image of the spoof category (for example, an image without including a genuine live object, for example, obtained by performing image collection on a biological object in a video or picture played on a screen, or a pre-printed biological object). The number of the spoof category is at least one, such as a category of a video biological object and a category of a picture biological object.

Operation 202: Invoke a liveness detection model to perform text encoding on each category text to obtain a category text feature of each category text, and perform feature extraction on the to-be-detected image to obtain a to-be-detected image feature.

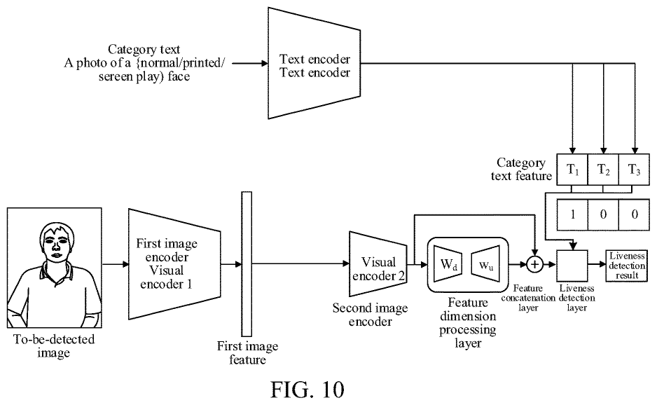

In operation 202, the liveness detection model is first invoked to perform text encoding on each category text, to obtain a category text feature of each category text. Then, the liveness detection model is invoked to perform feature extraction on the to-be-detected image, to obtain the to-be-detected image feature. As an example, FIG. 10 is a schematic structural diagram of a liveness detection model according to some embodiments. Herein, a structure of the liveness detection model is merely an example. The liveness detection model includes a text encoder (text encoder), a first image encoder (visual encoder 1), a second image encoder (visual encoder 2), and a feature dimension processing layer (including a dimension reduction processing layer (including a model parameter W_{d}) and a dimension increase processing layer (including a model parameter Wᵤ)), a feature concatenation layer, and a liveness detection layer.

In this way, based on the liveness detection model shown in FIG. 10, first, the text encoder may be invoked to perform text encoding on each category text (as shown in FIG. 10, 3 categories of category text in total (i.e., a number N of categories is equal to 3), including a photo of a normal face (corresponding to a live category), a photo of a printed face (corresponding to a spoof category, for example, a category of a biological object in a picture), and a photo of a screen play face (corresponding to a spoof category, for example, a category of a biological object in a video)), to obtain a category text feature of each category text, including category text features T₁, T₂, and T₃. Herein, T₁ corresponds to 1, representing that T₁ denotes the category text of a live category. T₂ corresponds to 0, representing that T₂ denotes the category text of a spoof category. T₃ corresponds to 0, representing that T₃ denotes the category text of a spoof category. Next, the first image encoder is invoked to perform image encoding on the to-be-detected image, to obtain a first image feature, and the second image encoder is invoked to perform image encoding on the first image feature, to obtain a second image feature; a dimension reduction processing layer of the feature dimension processing layer is invoked to perform feature dimension reduction processing on the second image feature, to obtain a third image feature, and a dimension increase processing layer of the feature dimension processing layer is invoked to perform feature dimension increase processing on the third image feature, to obtain a fourth image feature; and the second image feature and the fourth image feature are concatenated (such as, added), to obtain the to-be-detected image feature.

Operation 203: Invoke the liveness detection model to perform liveness detection based on the to-be-detected image feature and each category text feature, to obtain a liveness detection result of the to-be-detected image.

The liveness detection result includes a predicted probability that the biological object belongs to each category, and the categories include a live category and at least one spoof category.

The liveness detection model is trained based on the liveness detection model training method provided in some embodiments.

In operation 203, the liveness detection model is invoked to perform liveness detection based on the to-be-detected image feature and each category text feature, to obtain the liveness detection result of the to-be-detected image. Herein, the liveness detection result includes the predicted probability that the biological object belongs to each category (including a live category and at least one spoof category). In this way, whether the biological object is a genuine live object may be determined based on the predicted probability that the biological object belongs to each category in the liveness detection result. For example, a category corresponding to a maximum predicted probability is used as a target category to which the biological object belongs, if the target category is a live category, the biological object is a genuine live object, and if the target category is a spoof category, the biological object is not a genuine live object.

Further referring to FIG. 10, the liveness detection layer may be invoked to perform liveness detection based on the to-be-detected image feature and each category text feature, to obtain the liveness detection result of the to-be-detected image. Specifically, the liveness detection layer is invoked to perform liveness detection based on the to-be-detected image feature and each category text feature. The liveness detection result of the to-be-detected image may be obtained by using the following formula (2):

$${p}_{i} = \frac{exp ( {T}_{i} {F}_{v} ) / τ}{{\sum }_{j = 1}^{N} exp ( {T}_{j} {F}_{v} ) / τ} ; \qquad form ula ( 2 )$$

where pᵢ denotes the predicted probability that the biological object sample belongs to an i^{th} category, Tᵢ denotes a category text feature of the i^{th} category, Fᵥ denotes the to-be-detected image feature, t denotes a preset temperature coefficient, N denotes a number of categories, and Tⱼ denotes a category text feature of a j^{th} category.

By using the some embodiments, (1) the liveness detection model is trained by using the target augmented image feature of the image sample, the target augmented image feature is obtained by performing style augmentation on the image feature of the image sample based on the target style augmentation parameter, and the target style augmentation parameter is learned in a text-guided mode. The style of the image feature of the image sample can be diversified, so that when the liveness detection model is trained by using the target augmented image feature of the image sample, the training effect of the liveness detection model can be improved, thereby improving the model generalization capability and liveness detection precision of the trained liveness detection model. (2) Liveness detection is performed on the to-be-detected image based on the category text of various categories (including the live category and at least one spoof category), so that a strong semantic property of a text modality is utilized, and the liveness detection precision of the model is further improved.

In an exemplary scenario, some embodiments may be applied to a biometric payment scenario. Specifically, for an image sample (such as a facial image sample) collected from the biometric payment scenario, first description text of the image sample and second description text of the image sample in a target style are acquired. Style augmentation is performed on the image feature of the image sample based on the first description text and the second description text to obtain a first augmented image feature, and style augmentation is performed on the image feature based on a style augmentation parameter, to obtain a second augmented image feature. The style augmentation parameter is updated based on a difference between the second augmented image feature and the first augmented image feature, to obtain a target style augmentation parameter. Style augmentation is performed on the image feature based on the target style augmentation parameter, to obtain a target augmented image feature of the image sample, and the liveness detection model is trained based on the target augmented image feature, to obtain the trained liveness detection model. When the biometric payment is performed, a to-be-detected image including the biological object (such as a human face) is acquired, and the trained liveness detection model is invoked to perform liveness detection on the to-be-detected image to obtain a liveness detection result. The liveness detection result includes a predicted probability that the biological object in the to-be-detected image belongs to each category, and the categories include a live category and at least one spoof category. In this way, whether the biological object is a genuine live object may be determined based on the predicted probability that the biological object belongs to each category in the liveness detection result. For example, a category corresponding to a maximum predicted probability is used as a target category to which the biological object belongs, if the target category is a live category, the biological object is a genuine live object, and if the target category is a spoof category, the biological object is not a genuine live object. If the biological object is a genuine live object, payment is completed in a case that another payment verification succeeds. In this way, the liveness detection precision can be improved, thereby improving security of biometric payment.

In an exemplary scenario, some embodiments may be applied to a biometric unlocking (such as access control system unlocking or terminal device unlocking) scenario. Specifically, for an image sample (such as a facial image sample) collected from the biometric unlocking scenario, first description text of the image sample and second description text of the image sample in a target style are acquired. Style augmentation is performed on the image feature of the image sample based on the first description text and the second description text to obtain a first augmented image feature, and style augmentation is performed on the image feature based on a style augmentation parameter, to obtain a second augmented image feature. The style augmentation parameter is updated based on a difference between the second augmented image feature and the first augmented image feature, to obtain a target style augmentation parameter. Style augmentation is performed on the image feature based on the target style augmentation parameter, to obtain a target augmented image feature of the image sample, and the liveness detection model is trained based on the target augmented image feature, to obtain the trained liveness detection model. When the biometric unlocking is performed, a to-be-detected image including the biological object (such as a human face) is acquired, the trained liveness detection model is invoked to perform liveness detection on the to-be-detected image to obtain a liveness detection result. The liveness detection result includes a predicted probability that the biological object in the to-be-detected image belongs to each category, and the categories include a live category and at least one spoof category. In this way, whether the biological object is a genuine live object may be determined based on the predicted probability that the biological object belongs to each category in the liveness detection result. For example, a category corresponding to a maximum predicted probability is used as a target category to which the biological object belongs, if the target category is a live category, the biological object is a genuine live object, and if the target category is a spoof category, the biological object is not a genuine live object. If the biological object is a genuine live object, unlocking is performed in a case that another unlocking verification succeeds. In this way, the liveness detection precision can be improved, thereby improving security of biometric unlocking.

In an exemplary scenario, some embodiments may be applied to a biometric identity verification scenario. Specifically, for an image sample (such as a facial image sample) collected from the biometric identity verification scenario, first description text of the image sample and second description text of the image sample in a target style are acquired. Style augmentation is performed on a image feature of the image sample based on the first description text and the second description text to obtain a first augmented image feature, and style augmentation is performed on the image feature based on a style augmentation parameter, to obtain a second augmented image feature. The style augmentation parameter is updated based on a difference between the second augmented image feature and the first augmented image feature, to obtain a target style augmentation parameter. Style augmentation is performed on the image feature based on the target style augmentation parameter, to obtain a target augmented image feature of the image sample, and the liveness detection model is trained based on the target augmented image feature, to obtain the trained liveness detection model. When the biometric identity verification is performed, a to-be-detected image including the biological object (such as a human face) is acquired, the trained liveness detection model is invoked to perform liveness detection on the to-be-detected image to obtain a liveness detection result. The liveness detection result includes the predicted probability that the biological object in the to-be-detected image belongs to each category, and the categories include a live category and at least one spoof category. In this way, whether the biological object is a genuine live object may be determined based on the predicted probability that the biological object belongs to each category in the liveness detection result. For example, a category corresponding to a maximum predicted probability is used as a target category to which the biological object belongs, if the target category is a live category, the biological object is a genuine live object, and if the target category is a spoof category, the biological object is not a genuine live object. If the biological object is a genuine live object, it is confirmed that the identity verification succeeds in a case that another identity verification succeeds. In this way, the liveness detection precision can be improved, thereby improving security of biometric identity verification.

An exemplary application of some embodiments in an actual application scenario is described below by taking face liveness detection as an example. Face liveness detection is a key operation in a face recognition procedure. With application of a face recognition system in production and life, more and more presentation attack data is continuously generated. However, the data may have a difference with the attack data in the training sample set in domain information such as a human face, illumination, background, and an attack type, for example, data distribution of the data is different. Therefore, the liveness detection model obtained based on the training sample set is directly transferred to test data. Consequently, due to insufficient generalization capability, the model detection accuracy decreases. In the related art, to improve model generalization performance, a domain generalization technology based on unimodality (i.e., an image) is mostly used. This has limitations.

Therefore, some embodiments provides a liveness detection method based on text-guided efficient domain generalization. By introducing a text modality, the model generalization capability is further improved by using a modeling capability of text for styles and content. Specifically, some augmented image features different from a style of the training sample set are generated through guidance of the text modality, and source-domain image features are transferred to different styles, thereby enriching image features of training data of a model, improving the style diversity of the image features of the training samples, and further improving generalization effect of the model. Furthermore, some embodiments further provides a multi-modality matching and classification mechanism to perform liveness detection. By using a strong semantic property of the text modality, it outperforms a unimodality method in the related art.

In some exemplary scenarios, liveness detection is usually combined with another technology in practical application, such as a face authentication. As a first line of defense, liveness detection controls a critical link of authentication security. Face authentication has been applied to various scenarios, such as remote authentication, face payment, remote verification, and access control systems. For example, in a remote account opening process of bank X, to verify a genuine identity of an account holder, a remote face authentication technology is employed, and liveness detection is further applied to the remote face authentication. A process is as follows: firstly, a user may acquire an image including a human face by using a camera on a front end of an application; the front end transmits this image to a back end and invokes a liveness detection model; and liveness detection is performed by a remote authentication model, an authentication result is returned to the front end, if a live object is determined, the authentication is successful, and if a spoof object is determined, the authentication fails. For example, face authentication further plays an important role in a face payment process. Liveness detection is an important link for controlling payment security. A high-precision liveness detection method may reject some transactions attempted to be performed by an illegal attack, thereby ensuring the security of the transactions and ensuring that the user interests are not harmed. For example, in an access control system, to improve the authentication efficiency, after a face image is acquired directly by the front end, the face image is transmitted to the front-end embedded liveness detection model for direct detection, and a liveness detection result is fed back.

Detailed descriptions are provided below. First, a learning process of a target style augmentation parameter A is described. Referring to FIG. 5, a model at this stage includes: a first image encoder Vₐ, a second image encoder V_{b}, a text encoder, and a style augmentation parameter A. At this stage, only the target style augmentation parameter A is learned, and the remaining parameters are completely frozen.

In this way, text encoding is performed on first description text (i.e., a photo taken in a bright environment) by using the text encoder, to obtain a first text feature (i.e., T_{source}), and text encoding is performed on the second description text (i.e., a photo taken in yellow ambient light) by using the text encoder, to obtain a second text feature (i.e., T_{style}). The first text feature is subtracted from the second text feature, to obtain a text feature difference (i.e., ΔT=T_{style}−T_{source}). Image encoding is performed on the image sample I by using a first image encoder to obtain the image feature (i.e., F=Vₐ(I)), and image encoding is performed on the image feature by using a second image encoder to obtain an encoded image feature (i.e., V_{b}(F)). The text feature difference ΔT and the encoded image feature V_{b}(F) are added to obtain a first augmented image feature (i.e., F_{gt}=V_{b}(F)+ΔT). The style augmentation parameter A0 and the image feature F are added to obtain a first addition result, and image encoding is performed on the first addition result, to obtain a second augmented image feature (i.e., F_{pred}=V_{b}(F+A0)).

Based on this, a value of a loss function may be determined by using the loss function shown below, and then the style augmentation parameter A0 is updated based on the value of the loss function, to obtain the target style augmentation parameter A:

$$L = 1 - cos ( {F}_{pred} , {F}_{gt} ) + {L}_{1} ( {F}_{pred} , {V}_{b} ( F ) ) ; \qquad formula ( 1 )$$

where L denotes the value of the loss function, 1−cos (F_{pred}, F_{gt}) denotes a value of a first loss function that can constrain the second augmented image feature to approximate the first augmented image feature; L₁(F_{pred}, V_{b}(F)) denotes a value of a second loss function that can constrain a distance between the second augmented image feature and the image feature without undergoing style augmentation not to exceed a distance threshold.

Second, a training process of the liveness detection model is described. In some embodiments, as shown in FIG. 8, (1) the model at this stage includes: a first image encoder Vₐ, a second image encoder V_{b}, a text encoder, a target style augmentation parameter A, and an efficient training module Adapter (i.e., the foregoing feature dimension processing layer, including to-be-learned model parameters W_{d} and Wᵤ). Only the to-be-learned model parameters W_{d} and Wᵤ of the efficient training module Adapter are trained at this stage, and parameters of the remaining modules are completely frozen. (2) Image-text spatial consistency: in some embodiments, to improve robustness of the model, consistent fine-tuning training of an image-text feature is performed, liveness detection is performed in a semantic matching mode, and model generalization is facilitated by using general semantic knowledge. (3) Considering a high training cost required for fully fine-tuning a pre-trained model, some embodiments designs an efficient training module Adapter to perform fine tuning specifically for a liveness detection task, achieving an effect of full fine-tuning with only a small number of parameters. (4) By performing joint training on target augmented image features undergoing multiple style augmentation and source domain data, more diverse image features are inputted to the model. Therefore, the model is more robust and has generalization. (5) A model training process is as follows:
(5.1) First, an image sample 1 is encoded by a first image encoder to obtain an image feature F=Vₐ(I). Category text that may represent a live category and a spoof category (i.e., attack data) is set in terms of text, and is written as t. The category text feature is obtained by using the text encoder, and is written as T whose dimension is [N, C], where N denotes a number of categories, and C denotes a number of channels.
(5.2) Whether style augmentation may be performed on the image feature F of the image sample 1 is determined. If the augmentation may be performed, the image feature outputted by Adapter is Adapter (V_{b}(F+A)), and if the augmentation does not need to be performed, the outputted image feature is Adapter (V_{b}(F)). In this way, the predicted probability

$${p}_{i}^{′} = \frac{exp ( {T}_{i} {E}_{v} ) / τ}{{\sum }_{j = 1}^{N} exp ( {T}_{j} {E}_{v} ) / τ}$$

of the image sample 1 is obtained, where pᵢ′ denotes the predicted probability that the image sample belongs to an i^{th} category, Tᵢ denotes the category text feature of the i^{th} category, Ey denotes an added feature (i.e., Adapter (V_{b}(F+A))+V_{b}(F+A), or Adapter (V_{b}(F))+ (V_{b}(F))), t denotes a preset temperature coefficient, N denotes a number of categories, and Tⱼ denotes the category text feature of a j^{th} category. In this way, the value L(θ) of the loss function of the liveness detection model is determined by using the following formula (3):

$$L ( θ ) = - {\sum }_{i = 1}^{N} {y}_{i} log ( {p}_{i}^{′} ) ; \qquad formula ( 3 )$$

where yᵢ denotes a real label indicating that the image sample belongs to the i^{th} category (1 represents that the image sample belongs to the i^{th} category, and 0 represents that the biological object sample in the image sample does not belong to the i^{th} category).

In some embodiments, the efficient training module herein may further be implemented in a mode such as Side Adapter, Prompt Tuning, LoRA, or Visual Prompt Tuning.

In the foregoing embodiments of this application, a generalization capability of the liveness detection model for the image features of a plurality of styles is enhanced, the model training effect is improved, and the liveness detection precision of the liveness detection model is further improved.

The following continues to describe an exemplary structure of a liveness detection model training apparatus 555 provided in some embodiments that is implemented as a software module. In some embodiments, as shown in FIG. 2, software modules in the liveness detection model training apparatus 555 stored in a memory 550 may include: a first acquisition module 5551, configured to acquire an image sample for training a liveness detection model, and acquire first description text of the image sample and second description text of the image sample in a target style; a style augmentation module 5552, configured to perform style augmentation on the image feature of the image sample based on the first description text and the second description text to obtain a first augmented image feature, and perform style augmentation on the image feature based on a style augmentation parameter to obtain a second augmented image feature; and an update module 5553, configured to update the style augmentation parameter based on a difference between the second augmented image feature and the first augmented image feature to obtain a target style augmentation parameter; and a training module 5554, configured to perform style augmentation on the image feature based on the target style augmentation parameter when the liveness detection model is trained, to obtain a target augmented image feature of the image sample, and train the liveness detection model based on the target augmented image feature, to obtain a trained liveness detection model.

In some embodiments, the style augmentation module 5552 is further configured to perform text encoding on the first description text to obtain a first text feature, and perform text encoding on the second description text to obtain a second text feature; perform image encoding on the image feature of the image sample to obtain an encoded image feature; and fuse the second text feature, the first text feature, and the encoded image feature, to obtain the first augmented image feature.

In some embodiments, the style augmentation module 5552 is further configured to determine a text feature difference between the second text feature and the first text feature; and fuse the text feature difference and the encoded image feature, to obtain the first augmented image feature.

In some embodiments, the style augmentation module 5552 is further configured to fuse the style augmentation parameter and the image feature, to obtain a first fusion result; and perform image encoding on the first fusion result, to obtain the second augmented image feature.

In some embodiments, the style augmentation parameter belongs to a machine learning model. The update module 5553 is further configured to acquire a loss function of the machine learning model; determine a value of the loss function based on a difference between the second augmented image feature and the first augmented image feature; and update the style augmentation parameter of the machine learning model based on the value of the loss function, to obtain the target style augmentation parameter.

In some embodiments, the loss function includes a first loss function and a second loss function. The update module 5553 is further configured to determine a value of the first loss function based on the difference between the second augmented image feature and the first augmented image feature; determine a value of the second loss function based on a difference between the second augmented image feature and the image feature; and add the value of the first loss function and the value of the second loss function, to obtain the value of the loss function.

In some embodiments, the training module 5554 is further configured to acquire a sample selection mode prior to performing style augmentation on the image feature based on the target style augmentation parameter to obtain a target augmented image feature of the image sample; and select, based on the sample selection mode, a to-be-augmented image sample on which style augmentation is to be performed from an image sample set of the image sample. The training module 5554 is further configured to perform style augmentation on the image feature based on the target style augmentation parameter when the image sample having the image feature is the to-be-augmented image sample, to obtain the target augmented image feature of the image sample.

In some embodiments, the training module 5554 is further configured to train the liveness detection model based on the image feature when the image sample having the image feature is not the to-be-augmented image sample.

In some embodiments, the training module 5554 is further configured to fuse the target style augmentation parameter and the image feature, to obtain a second fusion result; and perform image encoding on the second fusion result, to obtain the target augmented image feature of the image sample.

In some embodiments, the training module 5554 is further configured to invoke the liveness detection model to perform liveness detection based on the target augmented image feature, to obtain a liveness detection result of the image sample; and train the liveness detection model based on a difference between the liveness detection result and a sample label of the image sample, to obtain a trained liveness detection model.

In some embodiments, the training module 5554 is further configured to acquire a plurality of pieces of category text prior to invoking the liveness detection model to perform liveness detection based on the target augmented image feature to obtain a liveness detection result of the image sample, the plurality of pieces of category text including first text representing a live category and second text representing each spoof category of at least one spoof category. The training module 5554 is further configured to invoke the liveness detection model to perform text encoding on each category text, to obtain a category text feature of each category text; invoke the liveness detection model to perform liveness detection based on the target augmented image feature and each of the category text features, to obtain a predicted probability that the biological object sample in the image sample belongs to each category, where the categories include the live category and the at least one spoof category, and the liveness detection result of the image sample includes the predicted probability that the biological object sample belongs to each category.

In some embodiments, the training module 5554 is further configured to perform feature dimension reduction processing on the target augmented image feature, to obtain an intermediate augmented image feature, and perform feature dimension increase processing on the intermediate augmented image feature, to obtain a target image feature; add the target augmented image feature and the target image feature, to obtain an added feature; and perform liveness detection based on the added feature and each of the category text features, to obtain the predicted probability that the biological object sample in the image sample belongs to each category.

In some embodiments, the training module 5554 is further configured to invoke a feature dimension processing layer of the liveness detection model, to perform feature dimension reduction processing on the target augmented image feature, to obtain an intermediate augmented image feature, and perform feature dimension increase processing on the intermediate augmented image feature, to obtain a target image feature. The training module 5554 is further configured to update a model parameter of the feature dimension processing layer based on a difference between the liveness detection result and a sample label of the image sample, to train the liveness detection model, to obtain the trained liveness detection model.

In some embodiments, the training module 5554 is further configured to train the liveness detection model based on the image feature prior to training the liveness detection model based on the target augmented image feature to obtain the trained liveness detection model, to obtain an intermediate liveness detection model. The training module 5554 is further configured to train the intermediate liveness detection model based on the target augmented image feature, to obtain the trained liveness detection model.

Some embodiments further provides a liveness detection apparatus, including: a second acquisition module, configured to acquire a to-be-detected image including a biological object and a plurality of pieces of category text, the plurality of pieces of category text including first text representing a live category and second text representing each spoof category of at least one spoof category; a feature extraction module, configured to invoke a liveness detection model to perform text encoding on each category text to obtain a category text feature of each category text, and perform feature extraction on the to-be-detected image to obtain a to-be-detected image feature; and a liveness detection module, configured to invoke the liveness detection model, and perform liveness detection based on the to-be-detected image feature and each category text feature, to obtain a liveness detection result of the to-be-detected image, where the liveness detection result includes a predicted probability that the biological object belongs to each category, and the categories include the live category and the at least one spoof category, and the liveness detection model is trained based on the liveness detection model training method provided in some embodiments.

Descriptions of the apparatus embodiments in this application are similar to the descriptions of the foregoing method embodiments, and have beneficial effects similar to the beneficial effects of the method embodiments. Unexhausted technical details in the apparatus provided in some embodiments may be understood based on the description of the technical details in the foregoing method embodiments.

Some embodiments further provides a computer program product. The computer program product includes computer-executable instructions or a computer program. The computer-executable instructions or the computer program is stored in a computer-readable storage medium. A processor of an electronic device reads the computer-executable instructions or the computer program from the computer-readable storage medium, and the processor executes the computer-executable instructions or the computer program, so that the electronic device performs the method provided in some embodiments.

Some embodiments further provides a computer-readable storage medium, the computer-readable storage medium having computer-executable instructions stored therein, and the computer-executable instructions, when executed by a processor, causing the processor to perform the method provided in some embodiments.

In some embodiments, the computer-readable storage medium may be a memory such as a random access memory (RAM), a read-only memory (ROM), a programmable ROM (PROM), an electrically programmable ROM (EPROM), an electrically erasable PROM (EEPROM), a flash memory, a magnetic surface memory, an optical disk, or a CD-ROM; or may be any device including one of or any combination of the foregoing memories.

In some embodiments, the computer-executable instructions may be written in a form of a program, software, a software module, a script, or code according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may but may not necessarily correspond to a file in a file system, may be stored in a part of the file for storing other programs or data, for example, stored in one or more scripts in a hypertext markup language (HTML) document, stored in a single file specially used for the discussed program, or stored in a plurality of collaborative files (for example, files storing one or more modules, a subprogram, or a code part).

As an example, the computer-executable instructions may be deployed to be executed on one electronic device, on a plurality of electronic devices located at one site, or on a plurality of electronic devices distributed at a plurality of locations and connected by a communication network.

The foregoing descriptions are only an example of this application and are not intended to limit the scope of protection of this application. Any modification, equivalent replacement, or improvement made without departing from the spirit and scope of this application shall fall within the protection scope of this application.

What is claimed is:

1. A liveness detection model training method, performed by an electronic device, the method comprising:
acquiring an image sample for training a liveness detection model,
acquiring a first description text of the image sample and second description text of the image sample in a target style;
generating a first augmented image feature by performing style augmentation on an image feature of the image sample based on the first description text and the second description text;
generating a second augmented image feature by performing style augmentation on the image feature based on a style augmentation parameter;
updating the style augmentation parameter based on a difference between the first augmented image feature and the second augmented image feature;
acquiring a target style augmentation parameter based on the updated style augmentation parameter;
acquiring a target augmented image feature of the image sample by performing style augmentation on the image feature based on the target style augmentation parameter; and
training the liveness detection model based on the target augmented image feature.

2. The method according to claim 1, wherein the generating the first augmented image feature comprises:
performing text encoding on the first description text and obtaining a first text feature;
performing text encoding on the second description text and obtaining a second text feature;
performing image encoding on the image feature of the image sample and obtaining an encoded image feature; and
fusing the second text feature, the first text feature, and the encoded image feature and obtaining the first augmented image feature.

3. The method according to claim 2, wherein the fusing comprises:
determining a text feature difference between the second text feature and the first text feature; and
fusing the text feature difference and the encoded image feature and obtaining the first augmented image feature.

4. The method according to claim 1, wherein the generating the second augmented image feature comprises:
fusing the style augmentation parameter and the image feature and obtaining a first fusion result; and
performing image encoding on the first fusion result and obtaining the second augmented image feature.

5. The method according to claim 1,
wherein the style augmentation parameter belongs to a machine learning model,
wherein the updating comprises:
acquiring a loss function of the machine learning model;
determining a value of the loss function based on the difference between the first augmented image feature and the second augmented image feature; and
updating the style augmentation parameter of the machine learning model based on the value of the loss function and obtaining the target style augmentation parameter.

6. The method according to claim 5,
wherein the loss function comprises a first loss function and a second loss function;
wherein the determining a value of the loss function comprises:
determining a value of the first loss function based on the difference between the first augmented image feature and the second augmented image feature;
determining a value of the second loss function based on a difference between the second augmented image feature and the image feature; and
combining the value of the first loss function and the value of the second loss function and obtaining the value of the loss function.

7. The method according to claim 1, prior to the acquiring a target augmented image feature, the method further comprising:
acquiring a sample selection mode;
selecting, based on the sample selection mode, at least one candidate image sample on which style augmentation is to be performed from an image sample set of the image sample;
wherein acquiring the target augmented image feature comprises:
performing the style augmentation on the image feature based on the target style augmentation parameter and obtaining the target augmented image feature of the image sample when the image sample having the image feature is one of the at least one candidate image sample.

8. The method according to claim 7, the method further comprising:
training the liveness detection model based on the image feature in a case that the image sample having the image feature is not the at least one candidate image sample.

9. The method according to claim 1, wherein acquiring the target augmented image feature comprises:
fusing the target style augmentation parameter and the image feature and obtaining a second fusion result; and
performing image encoding on the second fusion result and obtaining the target augmented image feature.

10. The method according to claim 1, wherein the training comprises:
invoking the liveness detection model to perform liveness detection based on the target augmented image feature and obtaining a liveness detection result of the image sample; and
training the liveness detection model based on a difference between the liveness detection result and a sample label of the image sample and obtaining a trained liveness detection model.

11. The method according to claim 10, prior to the invoking, the method further comprising:
acquiring a plurality of pieces of category text, the plurality of pieces of category text comprising a first text representing a live category and a second text representing each spoof category of at least one spoof category;
wherein the invoking the liveness detection model further comprises:
performing text encoding, based on the liveness detection model, on each piece of category text and obtaining a category text feature of each piece of category text; and
performing liveness detection based on the target augmented image feature and the category text features and obtaining a predicted probability that a biological object sample in the image sample belongs to each category of a plurality of categories,
wherein the plurality of categories comprise the at least one live category and the at least one spoof category, and the liveness detection result of the image sample comprises the predicted probability that the biological object sample belongs to each category.

12. The method according to claim 11, wherein the performing liveness detection based on the target augmented image feature comprises:
performing feature dimension reduction on the target augmented image feature and obtaining an intermediate augmented image feature;
performing feature dimension increase on the intermediate augmented image feature and obtaining a target image feature;
combining the target augmented image feature and the target image feature and obtaining an added feature; and
performing liveness detection based on the added feature and the category text features and obtaining the predicted probability that the biological object sample belongs to each category.

13. The method according to claim 12, wherein the performing feature dimension reduction comprises:
invoking a feature dimension layer of the liveness detection model, to perform feature dimension reduction on the target augmented image feature and obtaining the intermediate augmented image feature;
performing feature dimension increase on the intermediate augmented image feature and obtaining the target image feature; and
wherein the training the liveness detection model comprises:
updating a model parameter of the feature dimension processing layer based on the difference between the liveness detection result and the sample label of the image sample and obtaining the trained liveness detection model.

14. The method according to claim 1, prior to the training, the method further comprising:
training the liveness detection model based on the image feature, to obtain an intermediate liveness detection model; and
wherein the training the liveness detection model comprises:
training the intermediate liveness detection model based on the target augmented image feature, to obtain the trained liveness detection model.

15. A liveness detection model training apparatus, comprising:
at least one memory configured to store program code; and
at least one processor configured to read the program code and operate as instructed by the program code, the program code comprising:
acquiring code configured to cause at least one of the at least one processor to acquire an image sample for training a liveness detection model;
text code configured to cause at least one of the at least one processor to acquire a first description text of the image sample and second description text of the image sample in a target style;
first generation code configured to cause at least one of the at least one processor to generate a first augmented image feature by performing style augmentation on an image feature of the image sample based on the first description text and the second description text;
second generation code configured to cause at least one of the at least one processor to generate a second augmented image feature by performing style augmentation on the image feature based on a style augmentation parameter;
updating code configured to cause at least one of the at least one processor to update the style augmentation parameter based on a difference between the first augmented image feature and the second augmented image feature;
parameter code configured to cause at least one of the at least one processor to acquire a target style augmentation parameter based on the updated style augmentation parameter;
feature code configured to cause at least one of the at least one processor to acquire a target augmented image feature of the image sample by performing style augmentation on the image feature based on the target style augmentation parameter; and
training code configured to cause at least one of the at least one processor to train the liveness detection model based on the target augmented image feature.

16. The apparatus according to claim 15, wherein the first generation code is further configured to cause at least one of the at least one processor to:
perform text encoding on the first description text and obtain a first text feature;
perform text encoding on the second description text and obtain a second text feature;
perform image encoding on the image feature of the image sample and obtain an encoded image feature; and
fuse the second text feature, the first text feature, and the encoded image feature and obtain the first augmented image feature.

17. The apparatus according to claim 16, wherein the first generation code is further configured to cause at least one of the at least one processor to:
determine a text feature difference between the second text feature and the first text feature; and
fuse the text feature difference and the encoded image feature and obtain the first augmented image feature.

18. The apparatus according to claim 15, wherein the second generation code is further configured to cause at least one of the at least one processor to:
fuse the style augmentation parameter and the image feature and obtain a first fusion result; and
perform image encoding on the first fusion result and obtain the second augmented image feature.

19. The apparatus according to claim 15,
wherein the style augmentation parameter belongs to a machine learning model,
wherein the updating code is further configured to cause at least one of the at least one processor to:
acquire a loss function of the machine learning model;
determine a value of the loss function based on the difference between the first augmented image feature and the second augmented image feature; and
update the style augmentation parameter of the machine learning model based on the value of the loss function and obtain the target style augmentation parameter.

20. A non-transitory computer-readable storage medium, storing computer code which, when executed by at least one processor, causes the at least one processor to at least:
acquire an image sample for training a liveness detection model;
acquire a first description text of the image sample and second description text of the image sample in a target style;
generate a first augmented image feature by performing style augmentation on an image feature of the image sample based on the first description text and the second description text;
generate a second augmented image feature by performing style augmentation on the image feature based on a style augmentation parameter;
update the style augmentation parameter based on a difference between the first augmented image feature and the second augmented image feature;
acquire a target style augmentation parameter based on the updated style augmentation parameter;
acquire a target augmented image feature of the image sample by performing style augmentation on the image feature based on the target style augmentation parameter; and
train the liveness detection model based on the target augmented image feature.
